(19) United States
(12) Patent Application Publication
(10) Pub. No.: US 2018/0010699 A1
(43) Pub. Date: Jan. 11, 2018

(54) SEALING VALVE

(71) Applicant: AISAN KOGYO KABUSHIKI KAISHA, Obu-shi (JP)

(72) Inventors: Kasumi MISHIMA, Toyoake-shi (JP); Makoto FUKUI, Nagoya-shi (JP); Naruto ITO, Nisshin-shi (JP); Masahiro KOBAYASHI, Toyohashi-shi (JP)

(73) Assignee: AISAN KOGYO KABUSHIKI KAISHA, Obu-shi (JP)

(21) Appl. No.: 15/633,158

(22) Filed: Jun. 26, 2017

(30) Foreign Application Priority Data
Jul. 6, 2016 (JP) 2016-134053

(51) Int. Cl. F16K 5/18; F16K 25/00; F16K 39/04

(52) U.S. Cl. CPC F16K 5/181; F16K 39/045; F16K 5/182; F16K 25/005

(57) ABSTRACT

A sealing valve is provided with a valve seat including a valve hole, a valve element to open and close the valve hole, and a seal member to seal between the valve element and the valve seat during full closing. The seal member includes a fixed part fixed to the valve seat, a contact part to be brought into contact with a seal surface of the valve element, and a constricted part provided between the fixed part and the contact part. The contact part is rotatable about the constricted part.

### CROSS-REFERENCE TO RELATED APPLICATIONS

This application is based upon and claims the benefit of priority from each of the prior Japanese Patent Application No. 2016-134053 filed on Jul. 6, 2016, the entire contents of which are incorporated herein by reference.

### BACKGROUND

### Technical Field

The present disclosure relates to a sealing valve to open and close a flow passage.

### Related Art

A sealing valve has conventionally been used to control supply or stop of a flow of fluid in a passage. Further it is conceivable to utilize an eccentric valve (a flow control valve with a valve element whose seal surface placed eccentrically from a rotating shaft) disclosed in WO 2016/002599, and improve the sealing property of this eccentric valve in a valve closed state and using it as a sealing valve. In this case, this sealing valve (the eccentric valve) may be provided with a seal part in a valve seat and configured to bring a valve element in intimate contact with (or press a valve element against) the seal part to sealingly close a passage.

### SUMMARY

### Technical Problems

In the sealing valve (the eccentric valve) mentioned above, however, in a fully closed state, depending, on a differential pressure between the front and the rear of the valve (i.e., a front-rear differential pressure), the seal part may be deformed in a direction away from the valve element, leading to the occurrence of fluid leakage. For instance, as shown in FIG. 13, when the pressure on an upstream side of the valve element 114 is positive (high), a deformable portion 121a of a seal part 121 is likely to be deformed in a direction away from the valve element 114. This may cause fluid leakage.

The present disclosure has been made in view of the circumstances to solve the above problems and has a purpose to provide a sealing valve capable of preventing leakage during full closing of the valve without being affected by a front-rear differential pressure.

### Means of Solving the Problem

To achieve the above purpose, one aspect of the disclosure provides a sealing valve comprising: a valve seat including a valve hole; a valve element configured to open and dose the valve hole; and a seal member configured to seal between the valve element and the valve seat during full closing, wherein the seal member includes a fixed part fixed to the valve seat, a contact part to be brought into contact with the valve element, and a constricted part provided between the fixed part and the contact part, and the contact part is rotatable about the constricted part.

### BRIEF DESCRIPTION OF THE DRAWING

FIG. 1 is a front view of a sealing valve in an embodiment;

FIG. 2 is a top view of the sealing valve in the embodiment;

FIG. 3 is a perspective partially cutaway view of a valve section in a fully closed state in which a valve element is seated on a seal member (a valve seat);

FIG. 4 is a perspective partially cutaway view of the valve section in a fully open state in which the valve element is located at a position most away from the seal member (the valve seat);

FIG. 5 is a side view of the valve element and part of a shaft;

FIG. 6 is a cross sectional view taken along a line A-A in FIG. 5;

FIG. 7 is a cross sectional view taken along a line B-B in FIG. 1;

FIG. 8 is a cross sectional view taken along a line C-C in FIG. 1;

FIG. 9 is a view showing a state of the valve element and the seal member when no front-rear differential pressure occurs during full closing;

FIG. 10 is an explanatory view to explain a shape of a contact part of the seal member;

FIG. 11 is a view showing a state of the valve element and the seal member when an upstream-side pressure is negative (low) during full closing;

FIG. 12 is a view showing a state of the valve element and the seal member when the upstream-side pressure is positive (high) during full closing; and

FIG. 13 is a partial cross sectional view of a conventional seal member.

### DETAILED DESCRIPTION OF THE EXEMPLARY EMBODIMENTS

A detailed description of an embodiment of a sealing valve embodying the present disclosure will now be given referring to the accompanying drawings. The present embodiment exemplifies that the disclosure is applied to a sealing valve operative switch between supply and shutoff of air flow to a fuel cell stack in a fuel cell system.

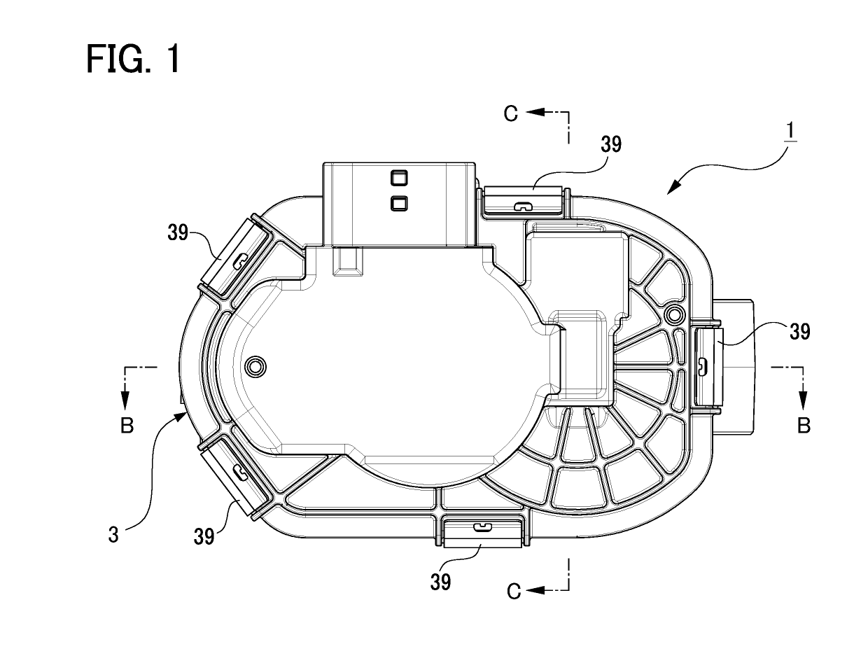

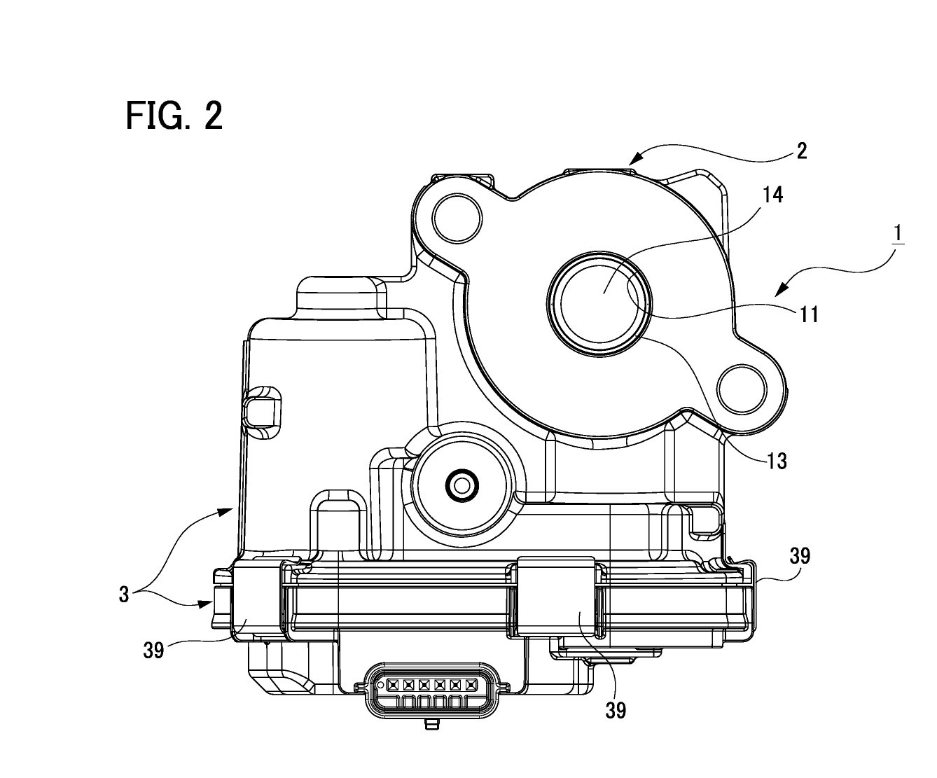

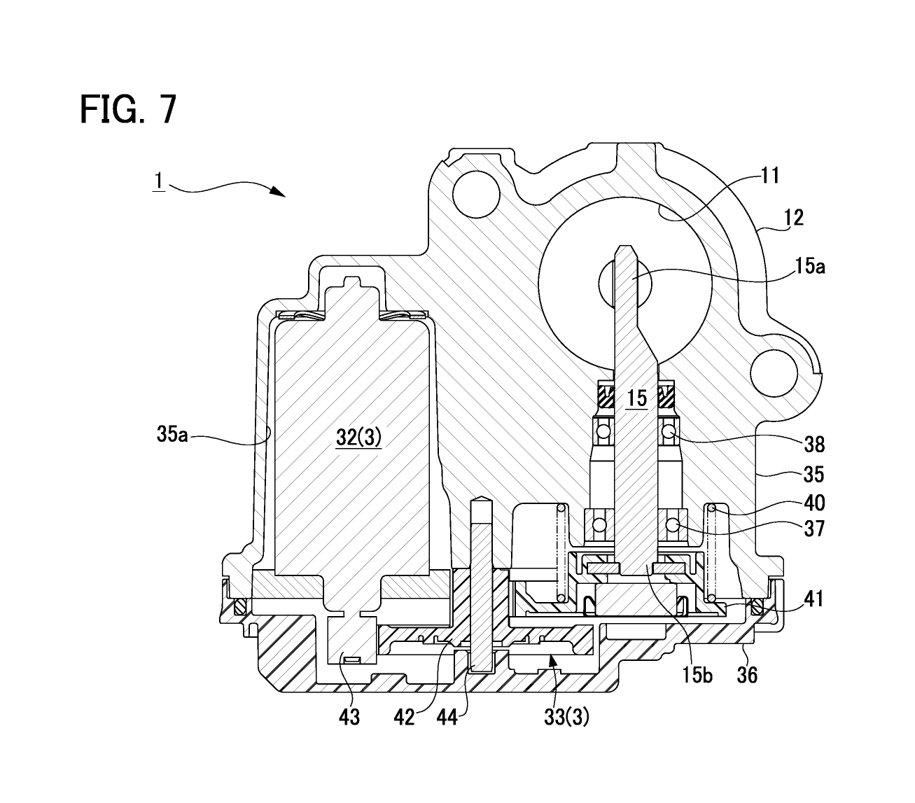

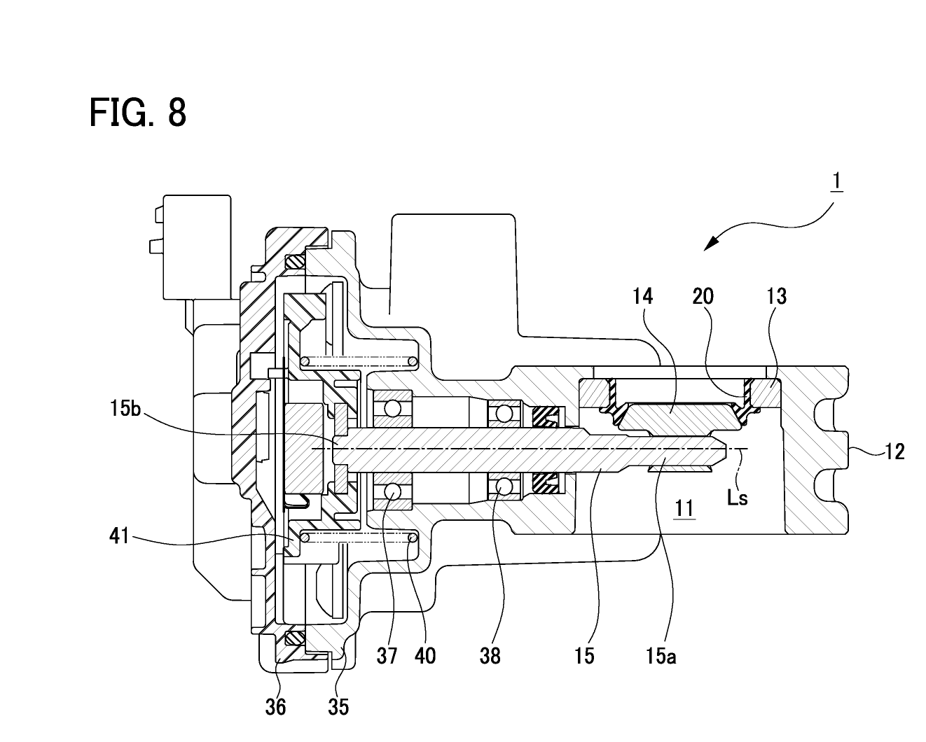

A sealing valve 1 includes, as shown in. FIGS. 1 and 2, a valve section 2 constituted as a double eccentric valve and a drive mechanism section 3. The valve section 2 is provided with a passage 11 for allowing a fluid, i.e., air, to flow in the valve section 2. In the passage 11, there are placed a valve seat 13, a valve element 14, and a shaft 15 (see FIGS. 7 and 8). The shaft 15 is configured to receive a driving force (torque) from the drive mechanism section 3. The drive mechanism section 3 is provided with a motor 32 and a speed reducing mechanism 33 (see FIGS. 7 and 8).

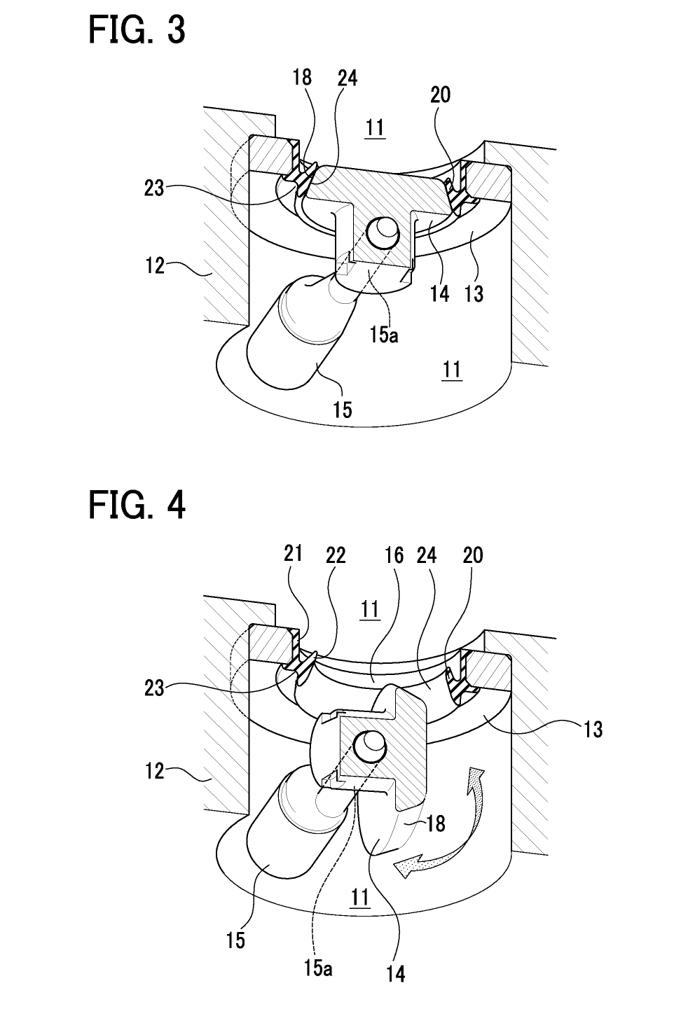

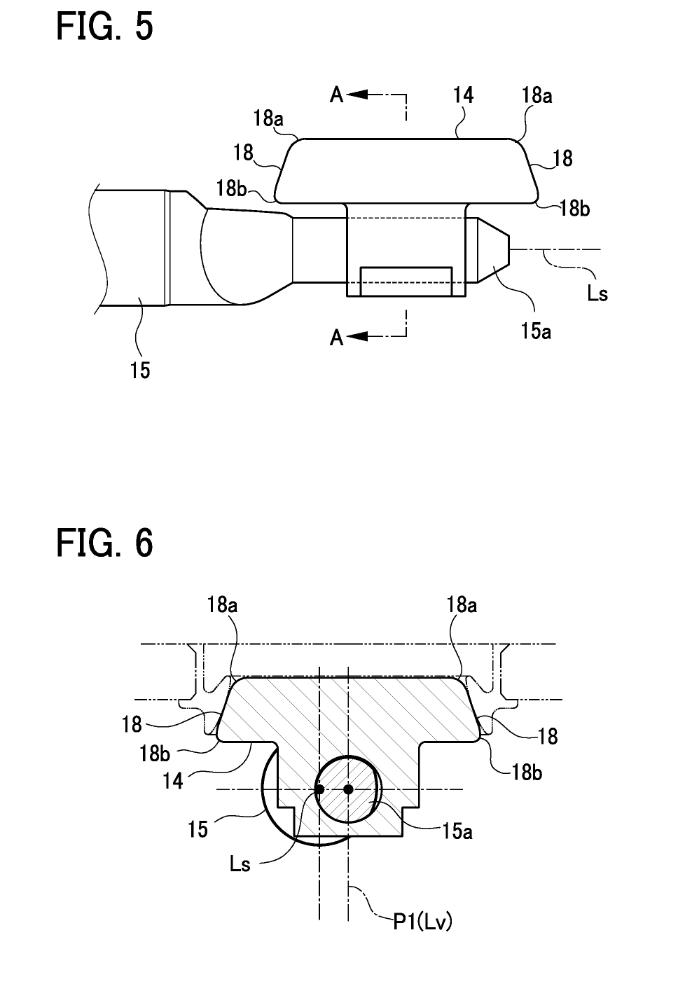

As shown in FIGS. 3 and 4, the valve seat 13 is installed in the passage 11. The valve seat 13 has a circular ring shape with a valve hole 16 at the center. A seal member 20 is fixed to the valve seat 13. The valve element 14 has a circular plate-shaped portion whose outer periphery is formed with an annular seal surface 18 to be brought into contact with the seal member 20. The seal surface 18 has rounded end portions 18a and 18b one at each end in an axial direction of the valve element 14 (see FIGS. 5 and 6). The valve element 14 is integrally provided with the shaft 15 and thus is rotatable together with the shaft 15. In FIGS. 3 and 4, the passage 11 above the valve seat 13 indicates an upstream side of air flow and the passage 11 below the valve element 14 indicates a downstream side of air flow. Specifically, the valve element 14 in the passage 11 is placed on a more downstream side of air flow than the valve seat 13.

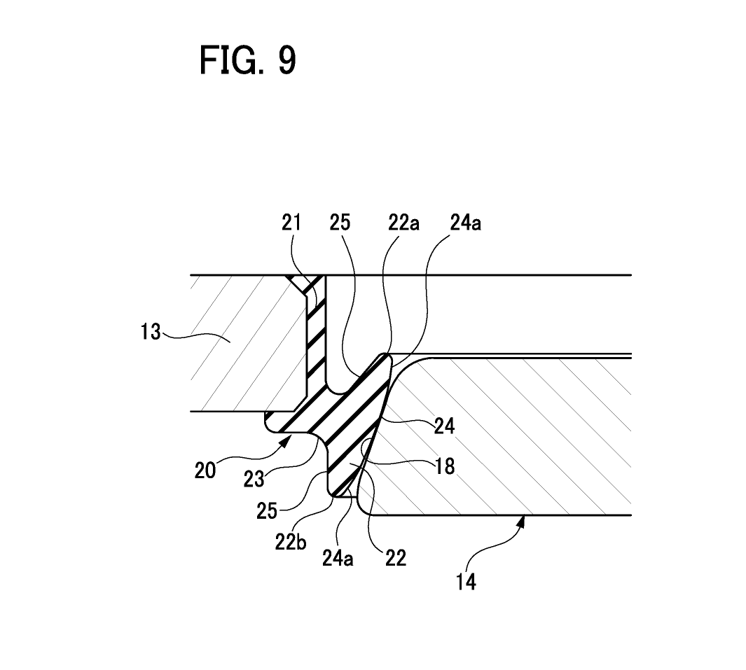

Herein, the seal member 20 is an annular robber sealing element as shown in FIGS. 3 and 4 including a fixed part 21 fixed to the valve seat 13, a contact part 22 to be brought into contact with the valve element 14, and a constricted part 23 provided between the fixed part 21 and the contact part 22. This seal member 20 is configured to rotate (swing) the contact part 22 around the constricted part 23. Further, the contact part 22 includes a facing surface 24 which faces the seal surface 18 of the valve element 14 during full closing. Specifically, this facing surface 24 is placed in surface contact with the seal surface 18 of the valve element 14, thereby enhancing the seal performance. The contact part 22 (the facing surface 24) has rounded end portions 22a and 22b one at each end in an axial direction of the seal member 20 (see FIG. 9).

Furthermore, as shown in FIG. 9, the facing surface 24 of the contact part 22 includes a non-contact surface 24a located out of contact with the seal surface 18 of the valve element 14 while no front-rear differential pressure is generated and the valve element 14 is in a fully closed state. In this state, the non-contact surface 24a has a surface area S1 smaller than a surface area S2 of a rear surface 25 of the contact part 22, opposite from the non-contact surface 24a, the rear surface 25 extending from each of the end portions 22a and 22b of the contact part 22 to the constricted part 23 (S1<S2). Accordingly, when a front-rear differential pressure occurs, the contact part 22 of the seal member 20 can be rotated so as to reliably press against the valve element 14. Thus, the contact part 22 can be tightly pressed against the valve element 14, thereby enabling prevention of leakage during full closing. The aforementioned relationship between the non-contact surface 24a and the rear surface 25 is established between the non-contact surface 24a and the rear surface 25 located on the upstream side and also between the non-contact surface 24a and the rear surface 25 located on the downstream side.

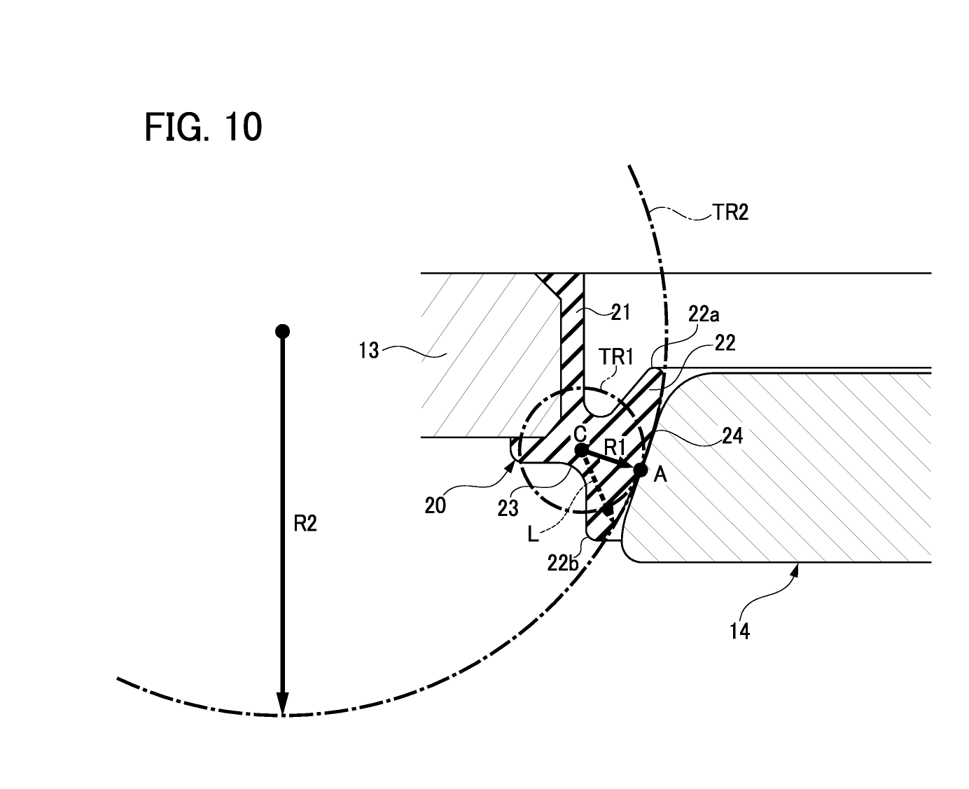

Moreover, as shown in FIG. 10, the facing surface 24 has a nearly circular-arc shape in section taken along a central axis direction and designed such that a distance L (a broken arrowed line) from a rotation center C of the contact part 22, positioned in the constricted part 23, to the acing surface 24 is gradually longer as a point on the facing surface 24 is closer from a seal point A between the seal member 20 and the valve element 14 to each of the end portions 22a and 22b of the contact part 22 in the axial direction of the seal member 20. In other words, the radius R1 of a rotation path TR1 of the contact part 22 is smaller than the radius R2 of a circle TR2 a part of which is defined by the facing surface 24 (R1<R2). Such a shape of the facing surface 24 makes it possible to tightly press the contact part 22 against the valve element 14 when the contact part 22 is rotated. This can prevent the occurrence of leakage during full closing.

As shown in FIGS. 5 and 6, a central axis Ls of the shaft 15 extends parallel with a radial direction of the valve element 14 and further eccentrically from a central axis Lv of the valve element 14 to one side in a radial direction of the valve element 14 (from the center P1 of the valve hole 16 to one side in a radial direction of the valve hole 16. Further, the seal surface 18 of the valve element 14 is positioned eccentrically from the central axis Ls of the shaft 15 toward an extending direction of the central axis Lv of the valve element 14. Thus, the valve section 2 is constituted as a double eccentric valve. By rotation of the valve element 14 about the central axis Ls of the shaft 15, the valve element 14 can be moved between a fully closed position in which the seal surface 18 of the valve element 14 is in surface contact with the seal member 20 (see FIG. 3) and a fully open position in which the seal surface 18 is most away from the seal member 20 (see FIG. 4).

As shown in FIGS. 1, 7, and 8, a valve housing 35 made of either metal or synthetic resin is provided with a bore part 12 formed with the passage 11 and a motor accommodating part 35a which accommodates the motor 32. In the valve housing 35, the valve element 14 and the shaft 15 are placed. The shaft 15 is provided with a pin 15a protruding as a distal end portion. This pin 15a is provided at one end (on the side close to the valve element 14) of the shaft 15 in the direction of the central axis Ls (see FIG. 8). In contrast, a proximal end portion 15b is provided at the other end (on the side close to the main gear 41) of the shaft 15 in the direction of the central axis Ls. As shown in FIGS. 7 and 8, the main gear 41 is fixed to the proximal end portion 15b of the shaft 15. A return spring 40 is provided between the valve housing 35 and the main gear 41.

The distal end portion of the shaft 15 formed with the pin 15a is a free distal end which is inserted and placed in the passage 11. The shaft 15 is supported in cantilever configuration through two bearings arranged apart from each other, that is, a first bearing 37 and a second bearing 38, so that the shaft 15 is rotatable with respect to the valve housing 35. The first bearing 37 and the second bearing 38 are each constituted of a ball hearing and press-fitted in the valve housing 35. Those first and second bearings 37 and 38 are placed between the valve element 14 and the main gear 41 in the direction of the central axis Ls of the shaft 15.

The shaft 15 is press-fitted in an inner ring of the first bearing 37 and further inserted in an inner ring of the second bearing 38. Accordingly, the shaft 15 is rotatably supported by the first bearing 37 and the second bearing 38. The valve element 14 is fixed by welding to the pin 15a formed in the distal end portion of the shaft 15. The valve element 14 is placed in the passage 11.

The motor 32 is housed and fixed in the motor accommodation part 35a formed in the valve housing 35 as shown in FIG. 7. The motor 32 is drivingly connected to the shaft 15 through the speed reducing mechanism 33 to open and close the valve element 14. Specifically, a motor gear 43 is fixed to an output shaft of the motor 32. This motor gear 43 is drivingly connected to the main gear 41 through an intermediate gear 42. The motor 32 generates a driving force to rotate the shaft 15 in a valve opening direction and in a valve closing direction.

The intermediate gear 42 is a double gear and rotatably supported in the valve housing 35 through a pin shaft 44. To the intermediate gear 42, the motor gear 43 and the main gear 41 are drivingly connected. In the present embodiment, the main gear 41, the intermediate gear 42, and the motor gear 43 are each made of resin material for weight saving.

An open end of the valve housing 35 is closed by an end frame 36 made of either metal or synthetic resin. The end frame 36 is secured to the valve housing 35 with a plurality of clips 39 (see FIGS. 1 and 2).

In the sealing valve 1 configured as above, when the motor 32 is energized from a fully closed state of the valve element 14 as shown in FIG. 3, the motor gear 43 is rotated in a forward direction (in a direction to open the valve element 14) by the motor driving three, which rotation is reduced in speed through the intermediate gear 42 and transmitted to the main gear 41. The shaft 15 fixed to the main gear 41 is rotated about the central axis Ls against a return spring force that is generated by the return spring 40 to urge the shaft 15 in a valve closing direction. Thus, the valve element 14 is rotated as indicated by an arrow in FIG. 4, opening the passage 11. Although the valve element 14 is in contact with the seal member 20 at that time, both end portions 18a and 18b of the seal surface 18 of the valve element 14 each having a rounded shape allow the valve element 14 to smoothly rotate without damaging the contact part 22 of the seal member 20. This can suppress wear of the seal member 20.

When drive voltage applied to the motor 32 is maintained constant in the course of rotation of the valve element 14, the motor driving force and the return spring force are balanced at a corresponding rotated position of the valve element 14. The valve element 14 is thus held at a predetermined opening degree. Thereafter, when energization of the motor 32 is stopped, the valve element 14 is rotated in the valve closing direction by the return spring force, thus closing the passage 11. At that time, the valve element 14 comes close to the seal member 20, contacts and presses the seal member 20 to form an interference (shrink range) with the seal member 20. However, the rounded end portions 22a and 22b of the contact part 22 can reliably prevent the contact part 22 from becoming entangled and damaged when the valve element 14 comes in contact with the seal member 20. This can also contribute to prevention of wear of the seal member 20. Since the seal member 20 is prevented from wearing down at the time of opening and closing of the valve element 14, as mentioned above, leakage prevention performance during full closing can be maintained for a long term.

Herein, when there is no front-rear differential pressure while the sealing valve I is in a fully closed state, as shown in FIG. 9, the valve element 14 presses against the seal member 20 (the contact part 22). Specifically, the seal surface 18 of the valve element 14 makes surface contact with the contact part 22 of the seal member 20. This can prevent the occurrence of leakage during full closing.

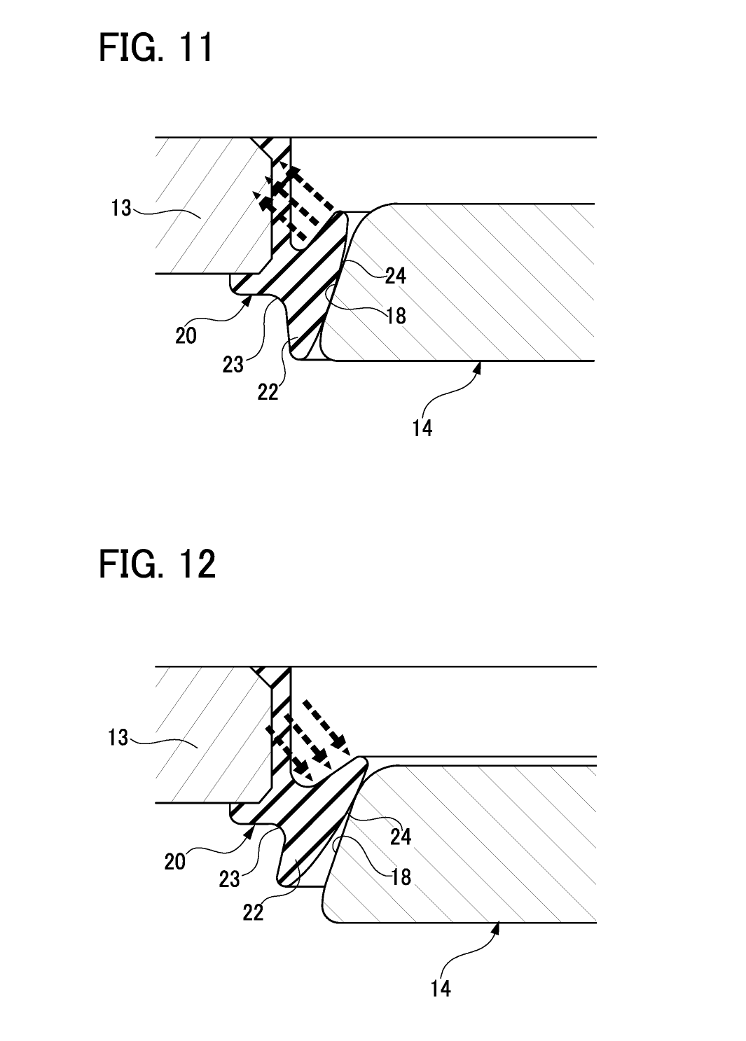

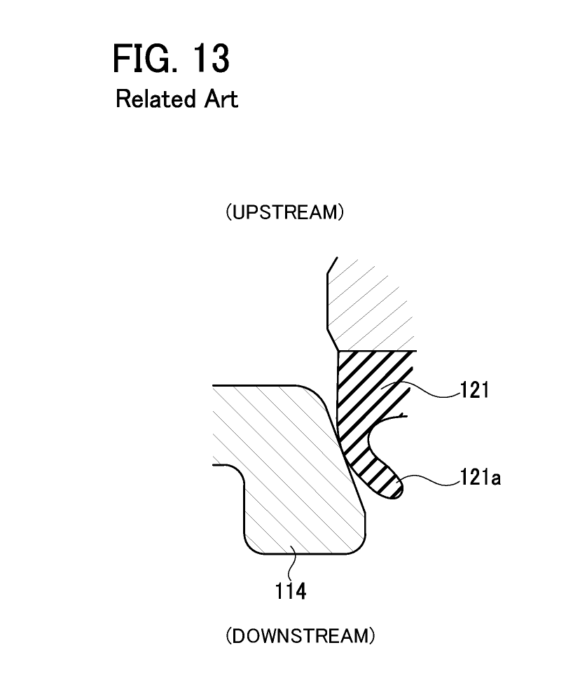

While the sealing valve 1 is in a fully closed state, further, when the pressure on an upstream side becomes negative (low), for example, generating a front-rear differential pressure, the valve element 14 is pushed to the upstream side by the front-rear differential pressure as shown in FIG. 11. Thus, the valve element 14 is pressed against the contact part 22 of the seal member 20. Further, the contact part 22 of the seal member 20 is pulled to the upstream side by the front-rear differential pressure and further rotated about the constricted part 23 to the upstream side. Accordingly, a downstream side portion of the contact part 22 located on the downstream side is pressed against the seal surface 1 of the valve element 14. Consequently, even when a negative pressure acts on the upstream side and thus a front-rear differential pressure occurs, leakage during full closing is prevented from occurring.

While the sealing valve 1 is in a fully closed state, on the other hand, when the pressure on an upstream side becomes positive (high), for example, generating a front-rear differential pressure, as shown in FIG. 12, the valve element 14 is pushed to the downstream side by the front-rear differential pressure. Thus, the valve element 14 may be separated from the contact part 22 of the seal member 20. In the scaling valve 1, however, since the surface area S1 of the non-contact surface 24a is smaller than the surface area S2 of the rear surface 25 opposite the non-contact surface 24a (S1<S2), the contact part 22 of the seal member 20 is reliably pushed to the downstream side by the front-rear differential pressure and thus is rotated about the constricted part 23 to the downstream side. The facing surface 24 of the contact part 22 has the nearly circular arc shape in section designed such that the distance L from the rotation center C of the contact part 22 to the facing surface 24 is gradually longer as a point on the facing surface 24 is closer from the seal point A between the seal member 20 and the valve element 14 to each of the end portions 22a and 22b of the contact part 22 in the axial direction. Thus, rotation of the contact part 22 to the downstream side causes an upstream-side portion of the contact part 22 to be reliably pressed against the seal surface 18 of the valve element 14. Accordingly, even when a positive pressure acts on the upstream side and thus a front-rear differential pressure occurs, leakage during full closing is prevented from occurring.

According to the sealing valve 1 in the present embodiment described in detail above, the seal member 20 includes the fixed part 21 fixed to the valve seat 13, the contact part 22 to be brought into contact with the valve element 14, and the constricted part 23 provided between the fixed part 21 and the contact part 22. The contact part 22 is rotatable about the constricted part 23. When either the negative pressure or the positive pressure acts on the upstream side during hill closing, causing a front-rear differential pressure to occur, the contact part 22 of the seal member 20 is rotated about the constricted part 23. By this rotating motion, the contact part 22 is pressed against the seal surface 18 of the valve element 14. This can prevent leakage during full closing without being affected by the front-rear differential pressure.

The aforementioned embodiment is a mere example and does not give any limitations to the present disclosure. The present disclosure may be embodied in other specific forms without departing from essential characteristics thereof. For instance, the aforementioned embodiment exemplifies the double eccentric valve as the sealing valve. The present disclosure is not limited to the double eccentric valve and may be applied to another type of sealing valve (e.g., a poppet valve).

In the aforementioned embodiment, the valve element 14 is placed on a more downstream side of air flow in the passage 11 than the valve seat 13. As an alternative, the valve element 14 may he placed, reversely, in the passage 11 on a more upstream side of air flow than the valve seat 13. That is, the direction of air flow in the passage 11 may be reversed. In this ease, similarly, the above-mentioned advantageous effects can be achieved and the sealing valve can prevent leakage during full closing without being affected by a front-rear differential pressure.

### REFERENCE SIGNS LIST

1 Sealing valve
2 Valve section
3 Drive mechanism section
11 Flow passage
13 Valve seat
14 Valve element
16 Valve hole
18 Seal surface
20 Seal member
21 Fixed part
22 Contact part
22a End portion
22b End portion
23 Constricted part
24 Facing surface
24a Non-contact surface
25 Rear surface

What is claimed is:

1. A sealing valve comprising:
a valve seat including a valve hole;
a valve element configured to open and close the valve hole; and
a seal member configured to seal between the valve element and the valve seat during full closing,
wherein the seal member includes a fixed part fixed to the valve seat, a contact part to be brought into contact with the valve element, and a constricted part provided between the fixed part and the contact part, and
the contact part is rotatable about the constricted part.

2. The sealing valve according to claim 1, wherein
the valve element has a seal surface,
the contact part has a facing surface located to face the seal surface of the valve element during full closing,
the facing surface of the contact part includes a non-contact surface located out of contact with the valve element while the valve element is in a fully closed state and no front-rear differential pressure occurs, and
the non-contact surface has a surface area smaller than a surface area of a rear surface of the contact part opposite the non-contact surface, the rear surface extending from each of end portions of the contact part to the constricted part.

3. The sealing valve according to claim 1, wherein the facing surface of the contact part has a nearly circular-arc shape in section designed such that a distance from a rotation center of the contact part located in the constricted part to the facing surface is longer as a point on the facing surface is closer from a seal point between the seal member and the valve element to each of both end portions of the contact part in an axial direction of the seal member.

4. The sealing valve according to claim 1, wherein the seal surface of the valve element has a rounded end portion at each end in an axial direction of the valve element.

5. The sealing valve according to claim 1, wherein the facing surface of the contact part has a rounded end portion at each end in an axial direction of the seal member.
